(19) United States
(12) Patent Application Publication
(10) Pub. No.: US 2007/0162364 A1
(43) Pub. Date: Jul. 12, 2007

(54) Method for charging for a service in a communication network

(76) Inventor: Walter Held, Geretsried (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/583,685

(22) PCT Filed: Dec. 2, 2004
(86) PCT No.: PCT/EP04/53227

§ 371 Date: Jun. 19, 2006

(30) Foreign Application Priority Data
Dec. 19, 2003 (EP) 03029454.0

(51) Int. Cl. G07F 19/00

(52) U.S. Cl. 705/34

(57) ABSTRACT

In one aspect an operator of a stateless proxy, or application broker to offer a reliable, trustworthy charging system which is accurate in definable intervals in a simple manner to registered application service suppliers, or registered clients, in which, during the provision of the service, the client and server are continuously provided with the charges applicable and the charging function, by means of an independent third party, including those from the independent third party is provided.

### CROSS REFERENCE TO RELATED APPLICATIONS

This application is the US National Stage of International Application No. PCT/EP2004/053227, filed Dec. 2, 2004 and claims the benefit thereof. The International Application claims the benefits of European application No. 03029454.0 EP filed Dec. 19, 2003, both of the applications are incorporated by reference herein in their entirety.

### FIELD OF INVENTION

The present invention relates to a method for charging for a service in a communication network.

### BACKGROUND OF INVENTION

In a packet-oriented communication network with service users (SIP clients, for example), service providers (application servers, for example), and an application broker acting as middleman (SIP proxy, for example), which is not integrated in this link for the duration of the service link between a client and an application server (that is, which is not a stateful SIP proxy), it is impossible for the proxy to provide a reliable charging function for registered customers (users and service providers). For reasons of efficiency (hardware and operating costs), it is advantageous for large network configurations having a plurality of proxies if a charging unit can work together with a plurality of proxies in the network at the same time.
Proxy remains in the communication link for the duration of the service link (stateful proxy), or
Billing operates separately between the application server and the client without involving the proxy, that is, the operator of the proxy is exclusively an access provider. An overall bill from one source including charges for the services used can then only be achieved, if at all, at great expense at the post-processing stage, with separate billing functions for the operator of the proxy and for the application server provider.

This requires a) assurance that the user of a service is at the same time also a customer of the proxy and service operator, and b) transmission of data to the central billing unit.

### SUMMARY OF INVENTION

The invention describes a method with which it is possible in such a scenario comprising a client, proxy (application broker, application brokering unit), charging unit (billing server) and application server, for reliable charging to be achieved for all the parties involved, the charging additionally representing a value-added service for the provider of the basic service (operator of the proxy and of the billing server). This provider is thus in a position to offer its end customer a reliable bill from one source with packet-oriented services from a very wide range of partner service providers. In such a set-up, the basic service provider can assume the role both of a simple broker of a service and also that of a middleman with “rebranding” (“rebranding” being understood here such that the operator of the proxy offers a service of a partner service provider not under the service's original name but under a product name of its own).

Ultimately, the aim of this method is

a) to bill registered end customers (clients) having a credit account in real time for charges for services requested and used, or

b) to provide registered end customers regularly (on a monthly basis, for example) for all the services used from various providers.

The method ensures that

a) the customer pays only for what he uses and

b) the service provider is paid for its services.

This method additionally makes it possible for the customer to have the option, even while the service is being used in real time, of having a display showing what charges have been run up for the service or, in the case of a prepaid service, how much credit is still remaining.

The basis of the above solution is a reliable charging function which integrates all the partner components (client, proxy/application broker, application server) while the service is being used.

Client: authenticates itself with a proxy and requests a service.

Proxy/application broker: brokers the requested service and initiates charging on the billing server.

Billing server: keeps an account of the use of this service by the client.

Application server: offers a service and informs the proxy with tickets of the setting up of and progress in the service link between itself and the client.

### BRIEF DESCRIPTION OF THE DRAWINGS

The invention is further explained by a drawing comprising three figures.

FIG. 1—A schematic of an exemplary embodiment of communication network according to the present invention.

FIG. 2—A schematic of a comparison of three exemplary embodiments;

FIG. 3—A schematic of an exemplary embodiment of a communication network having a plurality of proxies.

### DETAILED DESCRIPTION OF INVENTION

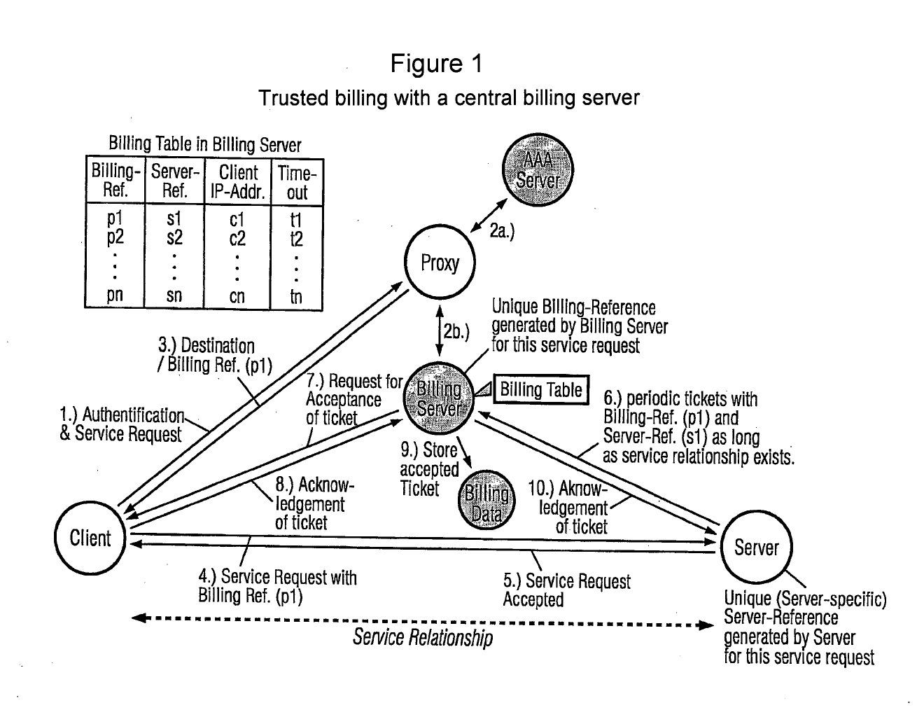

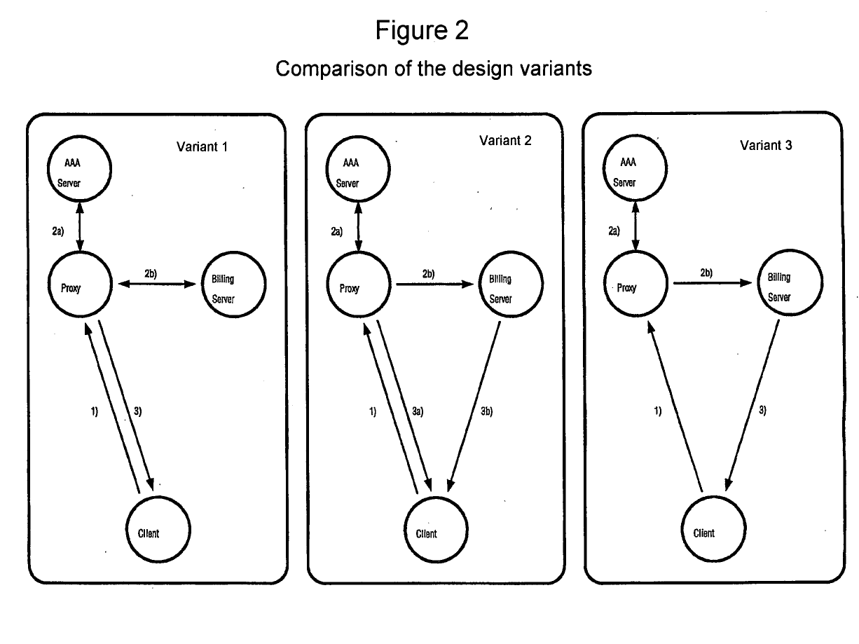

FIG. 1 shows the links between the partners and an outline of the procedures from the authentication of the client to the requesting and supplying of a service and finally to charging. These procedures are described hereafter with the aid of FIG. 1.
After the client has authenticated itself on the Authentication Authorization Accounting server (AAA server) by means of the proxy (1)/(2a), the proxy informs the billing server of the service request that is waiting. The billing server administers the billing table and also generates for it the references p1 for each service request. This reference is then sent back to the proxy (2b). The proxy then transmits to the client not only information as to the location of the application server (destination) and the billing reference (p1), but also the address of the billing server (3). As the service continues, the client, server and billing server communicate and the proxy is not involved.
With the information that it has received from the proxy, the client requests the desired service from the application server (4). The latter confirms the service request to the client (5). Thus the service link is established between the client and the application server.
After the service link has been set up between the client and the application server, and as long as the service is being used, the application server produces tickets at regular intervals (1 per minute, for example), which are then sent to the billing server (6). These tickets contain the reference p1, which allows the billing server to access the billing table efficiently, and the reference s1, which the server itself has set up and with which it can optionally access its data efficiently later on when it receives feedback from the billing server and can terminate an existing service relationship.
After receiving a ticket (6), the billing server determines the identity of the client on the basis of the reference p1 contained in the ticket (IP address C1) and requests from the client a confirmation of these billing data for each ticket received (7). If the confirmation has not been received after a certain time has elapsed (e.g. 1 second), the request (7) is repeated once or twice.
After receiving the request for confirmation, the client verifies the ticket and optionally sends a confirmation to the billing server (8).
After receiving a confirmation from the client, the billing server stores the ticket so that a bill can be drawn up at a later date (9) and informs the application server that the client has confirmed the ticket. In the case of a prepaid customer, the billing server updates the amount with which the customer is in credit.
   Special Cases in the Design Variant of the Invention Described:
Prepaid customer:
   If the amount in credit falls below a certain threshold, the billing server informs the client that the credit is almost used up. This can be achieved for example by the immediate request for confirmation for a ticket (7).
   If the credit has been used up, the billing server will delete the entry in the billing table and no longer accept further tickets from the application server for this customer and send a negative acknowledgement for these tickets to the application server, whereupon the application server will optionally terminate the service link to the client.
If a request for a ticket confirmation from the client (7) has been negatively acknowledged:
   The billing server informs the application server that a ticket has been negatively acknowledged, giving the reference s1 back to the application server. Using the reference s1, the server is then in a position to terminate the service link with the client.
If a ticket confirmation from the client has not been received despite repeated requests:
   The billing server informs the application server that it was unable to obtain a receipt for a ticket from the client, giving the reference s1 back to the application server. Using the reference s1, the server is then in a position to terminate the service link with the client.
If the timer t1 for the billing table entry runs out.
   In order to ensure the validity of a billing table entry, the billing server monitors the receipt of tickets from the application server. As soon as a ticket (6) comes in, the timer that has been set is reset. When the timer runs out, the entry in the table is deleted. Any subsequent tickets that then come in from the server are negatively acknowledged. A section of the message procedure (1)-(3), which is shown in FIG. 1 and has already been described, is shown in FIG. 2 for various design variants of the invention.

Design variant 1: The variant described in FIG. 1.

Design variant 2: Variant 2 differs from variant 1 in that the proxy, after the billing server has been informed of a request for a connection, no longer expects a billing reference (p1) from the proxy, but sends the reply to the client's service request back to the client without the p1 (3a). Instead the client then expects the billing reference from the billing server and only turns to the application server with the service request (4) when it has received the billing reference in a separate message (3b).

Correlation of the information in messages 3a) and 3b) with the original service request (1) is achieved via an existing unambiguous reference (call ID, tag) which is generated by the client for each service request and is contained in messages 2b), 3a) and 3b).

Design variant 3: Variant 3 differs from variant 2 in that in this case, the proxy itself does not send the client a reply to the original service request (1). After the billing server has been supplied by the proxy with all the relevant data (2b), the billing server generates a billing reference p 1 and sends it to the client in response to the service request (1), together with the data that it has received from the proxy.

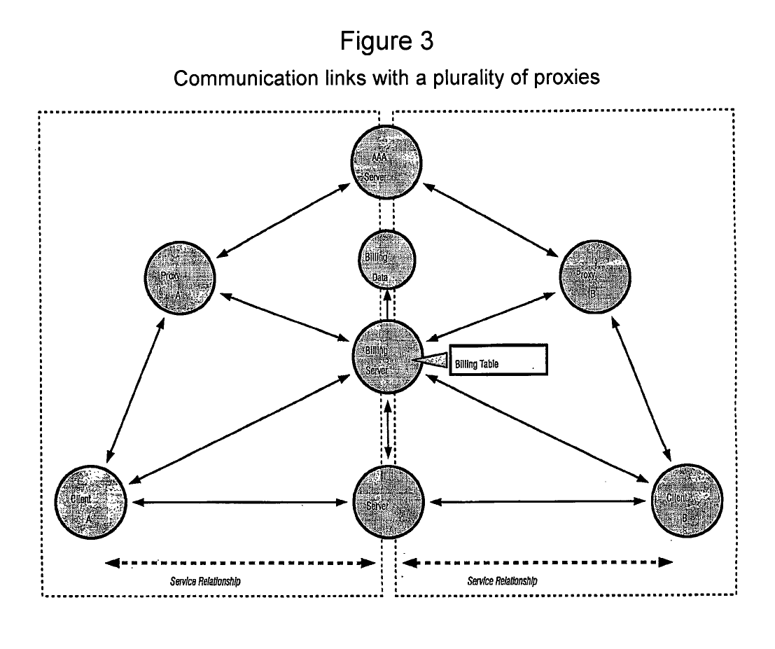

FIG. 3 shows how the billing server is integrated into the communication network as the partner of a plurality of proxies. It gives an outline of the arrangement of clients, application servers, proxies and a central billing server.

By having the billing servers optionally equipped with internal redundancy and by additionally being able to use a plurality of billing servers at the same time, this design variant will be highly accessible and at the same time highly scalable (m billing servers for n proxies and z application servers, m<n).

Observations

It should be noted that this method does not require the server and/or client to log off the billing server when the service link has been terminated. This means that even the sending of a billing ticket to the client always takes place in advance for the current billing interval. This ensures that the client does not use chargeable services without paying for them, since it simply disconnects the service before a billing interval has expired in order to avoid being charged for the interval that has just elapsed.
The time-out t1 in the billing table must always be longer than the length of the charging interval agreed between the client and the application server. It has to be long enough to prevent a ticket message to the billing server that has gone astray (and is therefore repeated by the application server) from leading the billing server to declare the billing table entry invalid. At the same time, however, t1 must not be too long in order to avoid, for example, denial of service attacks by malicious clients leading to a shortfall in billing table resources and ultimately to non-availability of these services. A sensible value for t1 is 2-3 times the length of the billing interval. Since the length of the billing intervals for the individual service links (see FIG. 1) can vary, the length of the time-out t1 is designed to be variable. As soon as the billing server receives a ticket from the application server, it uses the length of the billing interval quoted therein and determines therefrom the length of t1 in order to monitor the receipt of the next ticket from the application server for this service link. Until the first ticket has been received from the application server, a fixed initial value that is standard for the billing table is used for this timer (5 seconds, for example).
Possible confidence-building measures between the client and application server: the conditions for the service link (length and cost of the first interval, length and costs of the subsequent intervals) are agreed between the client and the server. By selecting a short first interval and optionally special conditions for this, it can be ensured even in a case of the service not being provided (e.g. server failure, overload, SW error, incompatibility of client and server software), despite the fact that a service link has been established, that the service user is not disadvantaged or is disadvantaged only to a slight extent.
If the billing server fails, the application server can optionally disconnect the service link to the client due to the fact that no receipt is generated for the ticket.
If the client fails, the customer's charge account will not continue to be billed in error by the billing server since the client is no longer in a position to quit further ticket confirmation requests from the billing server (see special cases).
Functionality for the client extendable to include for instance:
   i. Cumulation of the billing messages transmitted by the billing server and display of these charges on the terminal to allow monitoring of the charges in real time.
   ii. Possibility for end users to refuse manually in the form of option tickets, when, for example, a certain self-determined charge limit has been reached.

The invention can be summarized as follows. The method described allows the operator of a stateless proxy or application broker to provide registered application service providers and registered customers, in a simple manner by means of a billing server, with a reliable charging function that is trustworthy and accurate in definable intervals. The way that this is achieved is that, during the provision of the service, the client and server are continuously communicating in the background at regular intervals via an independent third party (billing server) regarding the charges applicable for the service, and the charging function is also facilitated by the independent third party, the charging function on the billing server being facilitated in particular for a plurality of proxies at the same time.

Examples of Applications

information services

video services

enhanced telephone services, such as conferences via conference servers

checking mailboxes

anonymous billing for gateways which are accessed via the open internet.

1.-18. (canceled)

19. A method for using a billing device for charging for a service in a communication network, comprising:
receiving a service request from a service brokering device;
generating a billing reference for a client with respect to the service request;
receiving a ticket issued by an application server, the ticket containing charge information relating to the service;
requesting a confirmation of charge information by a client; and
registering charges if the billing device receives the confirmation from the client.

20. The method according to claim 19, further comprising sending the billing reference directly to the client.

21. The method according to claim 19, further comprising sending the billing reference indirectly to the client via the service brokering device.

22. The method according to claim 19, wherein the registration of the charges is carried out equally for a prepaid client and for a billed client.

23. The method according to claim 19, wherein the registration of charges consists in the ticket being stored so that a bill can be generated later.

24. The method according to claim 23, wherein the registration of charges occurs in the device updating the client's level of credit or charges.

25. The method according to claim 24, further comprising:
informing the client if a credit level reaches or falls below a threshold; and
informing the application server if there are insufficient funds for a prepaid user.

26. The method according to claim 19, further comprising informing the client of charges incurred for the registration of charges.

27. The method according to claim 19, wherein the billing device receives service requests from a plurality of service brokering devices.

28. A method for using an application server for charging for a service in a communication network, comprising:
receiving a request for the service from a client, the service request containing a reference to a billing device;
generating a ticket for the service, the ticket containing information relating to a client charge that is due prior to or during the use of service;
sending the ticket to the billing device;
receiving from the billing device a message indicating if the ticket has been acknowledged by the client; and
maintaining a service relationship with the client if the ticket is positively acknowledged by the client.

29. The method according to claim 28, further comprising terminating the service relationship with the client if the ticket is negatively acknowledged.

30. The method according to claim 28, further comprising terminating the service relationship with the client if the message indicates the client has not acknowledged the ticket.

31. The method according to claim 28, further comprising terminating the service relationship with the client if the application server does not receive message from the billing device.

32. The method according to claim 28, further comprising:
receiving from the billing device an indication of insufficient funds for a client that is a prepaid user; and
terminating the service relationship with the client in response to receiving the indication of insufficient funds.

33. A method for a client in order to be charged for a service in a communication network, comprising:
requesting a service from a service brokering device;
receiving a reference for the service requested from the service brokering device;
establishing a service relationship between the client and an application server using the reference;
receiving a confirmation request from a billing device concerning charges due for the service; and
responding to the confirmation request;

34. The method according to claim 33, further comprising displaying the charges to an end user.

35. The method according to claim 34, wherein the display is in real time.

36. The method according to claim 34, wherein a plurality of confirmation requests are received and the charges are cumulated, the cumulated charges are displayed to the end user.

37. The method for billing for a service in a communication network, comprising:
requesting a service from the service brokering device by a client;
authenticating the client via the service brokering device;
generating a billing reference for the service request by a billing device;
responding to the client request by the brokering device with the billing reference and a billing device reference;
establishing a service relationship between the client and a server for the server by using the billing and billing device references;
producing a ticket by the server concerning charges for the service;
sending a confirmation request concerning the charges to the client by the billing device;
receiving a confirmation response from the client; and
recording the charges by the billing device if response to the confirmation response.

38. The method according to claim 37, further comprising:
sending information in the confirmation request to the application server; and
maintaining the service relationship by the application server if the confirmation response positively confirms the charges.
